(19) United States
(12) Patent Application Publication
(10) Pub. No.: US 2019/0121816 A1
(43) Pub. Date: Apr. 25, 2019

(54) PROGRAM CREATING DEVICE

(71) Applicant: Mitsubishi Electric Corporation, Tokyo (JP)

(72) Inventors: Kenichi SASAKI, Tokyo (JP); Hirofumi KAI, Tokyo (JP)

(73) Assignee: Mitsubishi Electric Corporation, Tokyo (JP)

(21) Appl. No.: 16/313,913

(22) PCT Filed: Apr. 17, 2017
(86) PCT No.: PCT/JP2017/015483

§ 371 Date: Dec. 28, 2018

(51) Int. Cl. G06F 16/25; G06F 16/2453; G06F 16/242

(52) U.S. Cl. CPC G06F 16/252; G06F 16/2428; G06F 16/24542; G06F 16/258

(57) ABSTRACT

A program creating device according to the present invention includes a definition information acquiring unit to acquire database definition information that is information indicating a configuration of a database in a programmable logic controller; and a program component generating unit to generate program components to be used in creating a program for operating the database on the basis of the database definition information.

### FIELD

The present invention relates to a program creating device that creates a program to be executed by a programmable logic controller.

### BACKGROUND

In recent years, cases where programmable logic controllers Hereinafter referred to as PLCs) handle large-volume data such as production recipes have been getting more common. In a case where large-volume data are to be treated by a ladder program, the program becomes complicated, it has been difficult to perform search for data and update of data that match a condition in the large-volume data. For that reason, PLCs having database functions have been becoming common (Patent Literature 1).

A PLC disclosed in Patent Literature 1 defines a database accessing instruction that is an instruction for operating a database as an instruction used in a ladder program to be executed by the PLC, and upon detecting the database accessing instruction, converts the database accessing instruction into an instruction in the Structured Query Language (SQL). This reduces the number of processes in operating a database so that large-volume data can be easily handled. The database accessing instruction has an instruction name corresponding to the operation in the SQL so that the database can be operated by the ladder program and has a condition assigned to a device. In addition, Patent Literature 1 discloses defining instructions such as reading data from the database, adding data to the database, changing data in the database, and deleting data from the database, as the database accessing instructions.

### CITATION LIST

### Patent Literature

Patent Literature 1: Japanese Patent No. 5518266

### SUMMARY

### Technical Problem

However, although an address of an argument in the database accessing instruction used by the PLC disclosed in Patent Literature 1 can be freely set by a user, the address is problematic in that the setting of the address is difficult. Specifically, the user needs to be aware of what is an item that is currently being set and what attributes are present in a database in accordance with an offset from a top device address, and carefully perform the setting. In addition, since the offsets of the items to be set vary depending on the definition of a database and a set value of an item at an upper level address, the same offset is not always associated with the same item. As described above, the database accessing instructions have made programming of large-volume data easier and also made search and editing simpler, but use of such database accessing instructions requires trial and error and some experience.

The present invention has been made in view of the above circumstances, and an object thereof is to provide a program creating device that enables elimination of complication of work for creating a program for a PLC having a database function, more specifically, work for creating a program for operating a database.

### Solution to Problem

In order to solve the aforementioned problems and achieve the object, the present invention provides a program, creating device configured to acquire database definition information that is information indicating a configuration of a database in a programmable logic controller and to generate a program component to be used for creating a program for operating the database on the basis of the database definition information.

### Advantageous Effects of Invention

A program creating device according to the present invention produces an effect of eliminating complication of work for creating a program for operating a database.

### BRIEF DESCRIPTION OF DRAWINGS

FIG. 1 is a diagram illustrating example configurations of a program creating device and a PLC according to a first embodiment.

FIG. 2 is a diagram illustrating a hardware configuration for implementing the program creating device according to the first embodiment.

FIG. 3 is a flowchart illustrating operation of the program creating device according to the first embodiment.

FIG. 4 is a diagram for explaining definition information of a table acquired by the program creating device according to the first embodiment.

FIG. 5 is a diagram illustrating an example of a screen displayed by the program creating device according to the first embodiment.

FIG. 6 is a diagram illustrating an example of a screen displayed by the program creating device according to the first embodiment after starting operation of acquiring definition information of a table from a user.

FIG. 7 is a diagram illustrating an example of a screen of the program creating device according to the first embodiment for receiving input of definition information of a table.

FIG. 8 is a diagram illustrating an example of a screen displayed by the program creating device according to the first embodiment after receiving input of the definition information of the table.

FIG. 9 is a diagram illustrating an example of a file included in DB definition files generated by the program creating device according to the first embodiment.

FIG. 10 is a diagram illustrating a stage in the process of operation of the pre-grant creating device according to the first embodiment generating a label.

FIG. 11 is a diagram illustrating a state after the program creating device according to the first embodiment has generated a label.

FIG. 12 is a diagram illustrating an example of a method for using a label generated by the program creating device according to the first embodiment.

FIG. 13 is a diagram illustrating an example of a function block generated by the program creating device according to the first embodiment.

FIG. 14 is a diagram illustrating an example of a screen displayed by the program creating device according to the first embodiment.

FIG. 15 is a diagram illustrating a first example of a ladder program created, by using the program creating device according to the first embodiment.

FIG. 16 is a diagram illustrating a second, example of a ladder program created, by using the program creating device according to the first embodiment.

FIG. 17 is a diagram illustrating a third example of a ladder program created by using the program creating device according to the first embodiment.

FIG. 18 is a diagram illustrating a fourth example of a ladder program created by using the program creating device according to the first embodiment.

FIG. 19 is a diagram illustrating examples of instructions obtained by converting a function block for database operation by the program creating device according to the first embodiment.

FIG. 20 is a diagram illustrating example configurations of a program creating device and a PLC according to a second embodiment.

### DESCRIPTION OF EMBODIMENTS

A program creating device according to embodiments of the present invention will be described in detail below with reference to the drawings. Note that, the present invention is not necessarily limited by these embodiments.

### First Embodiment

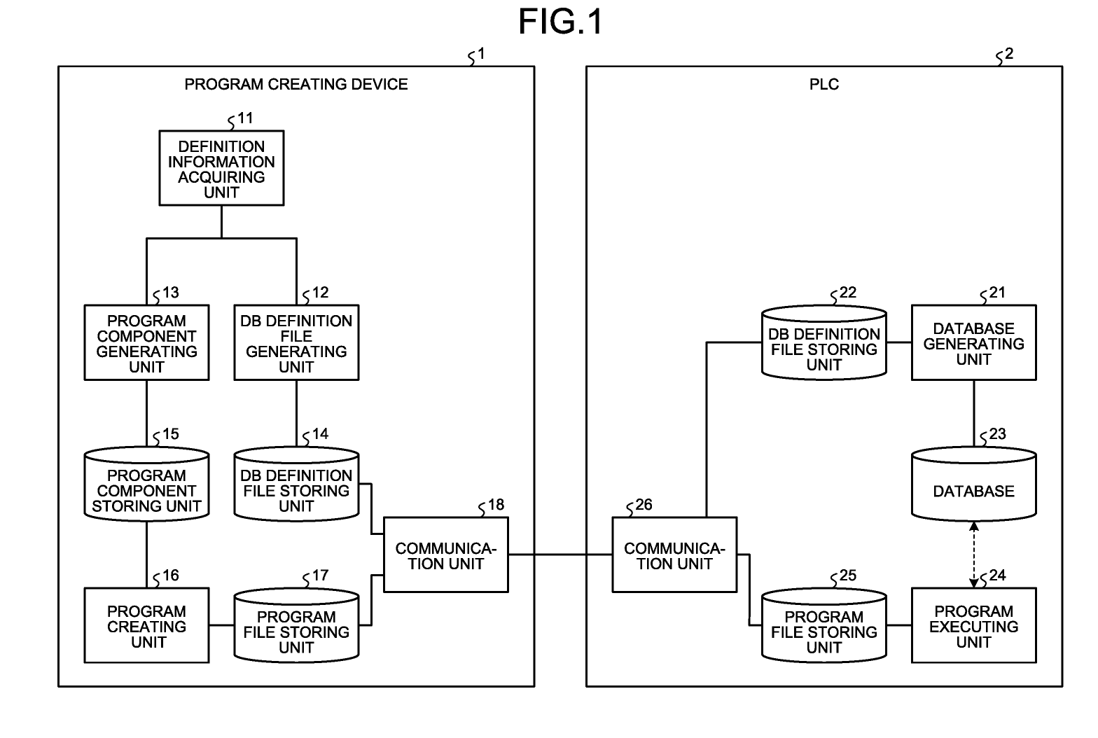

FIG. 1 is a diagram illustrating example configuration of a program creating device and a PLC that executes a program created by the program creating device according to a first embodiment of the present invention.

The program creating device 1 according to the first embodiment is a device for creating a program to be executed by the PLC 2, and includes a definition information acquiring unit 11, a database (DB) definition file generating unit 12, a program component generating unit 13, a DB definition file storing unit 14, a program component storing unit 15, a program creating unit 16, a program file storing unit 17, and a communication unit 18.

The PLC 2 is a programmable logic controller having a database function, and includes a database generating unit 21, a DB definition file storing unit 22, a database 23, a program executing unit 24, a program file storing unit 25, and a communication unit 26. Although not illustrated in FIG. 1, the PLC 2 is equipped with a database management system (DBMS) for building a database and performing various kinds of operations on the built database. Since one DBMS is a system typically used in devices having a database function, detailed description thereof will not be provided. Examples of various kinds of operations to be performed on the database include addition of data to the database, update of data in the database, deletion of data from the database, and searching for data in the database.

The components constituting the program creating device 1 will be briefly described. The definition, information acquiring unit 11 acquires definition information of a table constituting a database from a user who is a designer of a program. The DB definition file generating unit 12 generates a database definition file (hereinafter referred to as a DB definition file) of the database 23 built in the PLC 2 on the basis of the definition information acquired by the definition information acquiring unit 11. A DB definition file is obtained by making definition information of respective tables constituting the database 23 perpetuated in a form of a file. The program component generating unit 13 creates program components that can be used for creating a program for the PLC 2 on the basis of the definition information acquired by the definition information acquiring unit 11. The program components created by the program component generating unit 13 are program components that can be used for creating a program covering operations of the database 23. In addition, the program components created by the program component generating unit 13 serve as variable definitions which are also called labels, and function definitions which are also called function blocks (hereinafter referred to as FBs). The DB definition file storing unit 14 receives and stores the DB definition file generated by the DB definition file generating unit 12. The program component storing unit 15 receives and stores the program components generated by the program component generating unit 13. The program component storing unit 15 may also store program components other than the program components generated by the program component generating unit 13. Specifically, the program creating device 1 may have a function of creating a program component (not illustrated) in addition to the program component generating unit 13, and the program component storing unit 15 may store the program components created using this function.

The program creating unit 16 is configured to include a program editor and a compiler, to create a program and generate a program file in an executable form by compiling the created program. The program file storing unit 17 receives and stores the program file generated by the program creating unit 16. The communication unit 18 transmits the DE definition file stored in the DB definition file storing unit 14 and the program file stored in the program file storing unit 17 to the PLC 2. Note that the timing at which the communication unit 18 transmits the DB definition file to the PLC 2 and the timing at which the communication unit 18 transmits the program file to the PLC 2 are assumed to be different from each other, but the communication unit 18 may alternatively transmit the DB definition file and the program file at the same timing, namely, may transmit the two files together.

Next, the components constituting the PLC 2 will be briefly described. The database generating unit 21 generates the database 23 or the basis of the DB definition file which has been created by the program creating device 1 and stored in the DB definition file storing unit 22. The database generating unit 21 is implemented with use of the DBMS. The DB definition file storing unit 22 receives and stores the DB definition file generated by the program creating device 1 via the communication unit 26. The database 23 is constituted by one or more tables, and stores and manages data received from the program executing unit 24 in a specified table. The program executing unit 24 implements various kinds of functions of the PLC 2 by executing programs cremated by the program creating device 1 and stored in the program file storing unit 25. The program file storing unit 25 receives a program created by the program creating device 1 via the communication unit 26 and stores the program. The communication unit 26 receives the DB definition file and the program file which are created by the program creating device 1. When receiving a DB definition file, the communication unit 26 stores the DB definition file in the DB definition file storing unit 22, and when receiving a program, the communication unit 26 stores the program in the program file scoring unit 25.

Note that the DB definition file storing unit 22 may erase the DE definition file stored therein after the database 23 is generated by the database generating unit 21. In other words, the DB definition file storing unit 22 may be configured to temporarily hold the DB definition file received from the program creating device 1 until the database generating unit 21 generates the database 23.

The communication between the communication unit 18 of the program creating device 1 and the communication unit 26 of the PLC 2 may be based on cable communication or radio communication. In addition, the program creating device 1 need not be connected with the PLC 2 in creating a program for the PLC 2. Specifically, when creating a program for the PLC 2, the program creating device 1 may be in a condition in which the program creating device 1 cannot communicate with the PLC 2. The program creating device 1 only needs to be connected to the PLC 2 when data such as a created program, file, or the like need to be transmitted or received with the PLC 2.

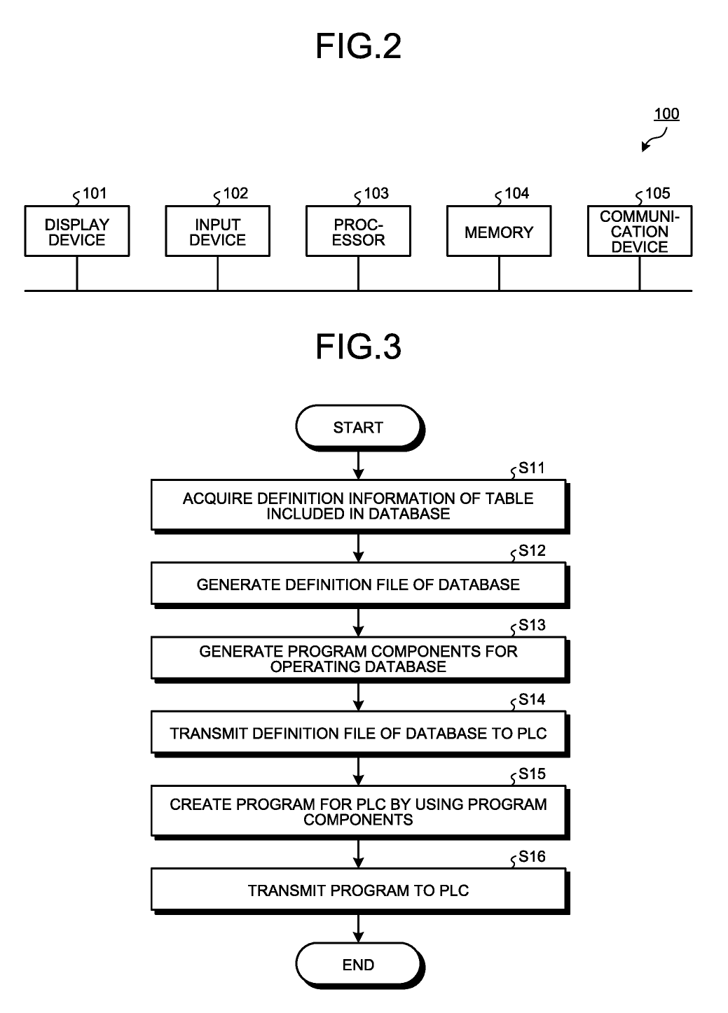

Here, a hardware configuration of the program creating device 1 will be described. FIG. 2 is a diagram illustrating a hardware configuration for implementing the program creating device 1 according to the first embodiment.

The program creating device 1 is implemented by hardware 100 including a display device 101, an input device 102, a processor 103, a memory 104, and a communication device 105. The display device 101 is a device that displays information, an example of which is a liquid crystal display, but the present invention is not limited to this example. The input device 102 is a device for inputting various kinds of information including characters to the program creating device 1, examples of which include a keyboard, a mouse, a pointing device, and a touch panel, but the present invention is not limited to the examples. The input device 102 is used for a case receiving various operations performed by the user. Specifically, the input device 102 is used when the definition information acquiring unit 11 receives input of definition information of a table from the user and when the program creating unit 16 receives an operation for program creation from the user. The input device 102 is also used tor receiving operations other than the above from the user. The communication device 105 is a device for transmitting and receiving various kinds of data including a DB definition file and a program file with the PLC 2, and implements the communication unit 18.

The functions of the definition information acquiring unit 11, the DB definition file generating unit 12, the program component generating unit 13, and the program creating unit 16 included in the program creating device 1 are implemented by the processor 103 and the memory 104. The processor 103 may also be referred to as a central processing unit (CPU), a processing device, a computing device, a microprocessor, a microcomputer, or a digital signal processor (DSP). The memory 104 may correspond to any of a volatile or nonvolatile semiconductor memories such as a random access memory (RAM), a read only memory (ROM), a flash memory, an erasable programmable read only memory (EPROM), and an electrically erasable programmable read only memory (EEPROM), a magnetic disk, a flexible disk, an optical disk, a compact disc, a mini disc, and a digital versatile disc (DVD).

The functions of the definition information acquiring unit 11, the DB definition file generating unit 12, the program component generating unit 13, and the program creating unit 16 are thus implemented by software, firmware, or combination of software and firmware. The software and firmware are described in the form of programs and stored in the memory 104. The processor 103 implements the functions of the definition information acquiring unit 11, the DB definition file generating unit 12, the program component generating unit 13, and the program creating unit 16 by reading and executing programs stored in the memory 104.

In other words, these programs cause a computer to execute procedures performed by the definition information acquiring unit 11, the DB definition file generating unit 12, the program component generating unit 13, and the program creating unit 16.

The DB definition file storing unit 14, the program component storing unit 15, and be program file storing unit 17 are implemented by the memory 104.

Note that, the PLC 2 can be implemented by the processor 103, the memory 104, and the communication device 103 of the hardware 100 illustrated in FIG. 2.

Next, overall operation of the program creating device 1 according to the first embodiment will be described with reference to FIG. 3. FIG. 3 is a flowchart illustrating the operation of the program creating device 1 according to the first embodiment. The flowchart of FIG. 3 illustrates the operation in a case where the program creating device 1 creates program components and a DB definition file.

The program creating device 1 first acquires definition information of each of tables of the database 23 to be built in the PLC 2 (step S11). Specifically, the definition information acquiring unit 11 receives input of definition information of each of tables constituting the database 23 from a user who is a designer of a program.

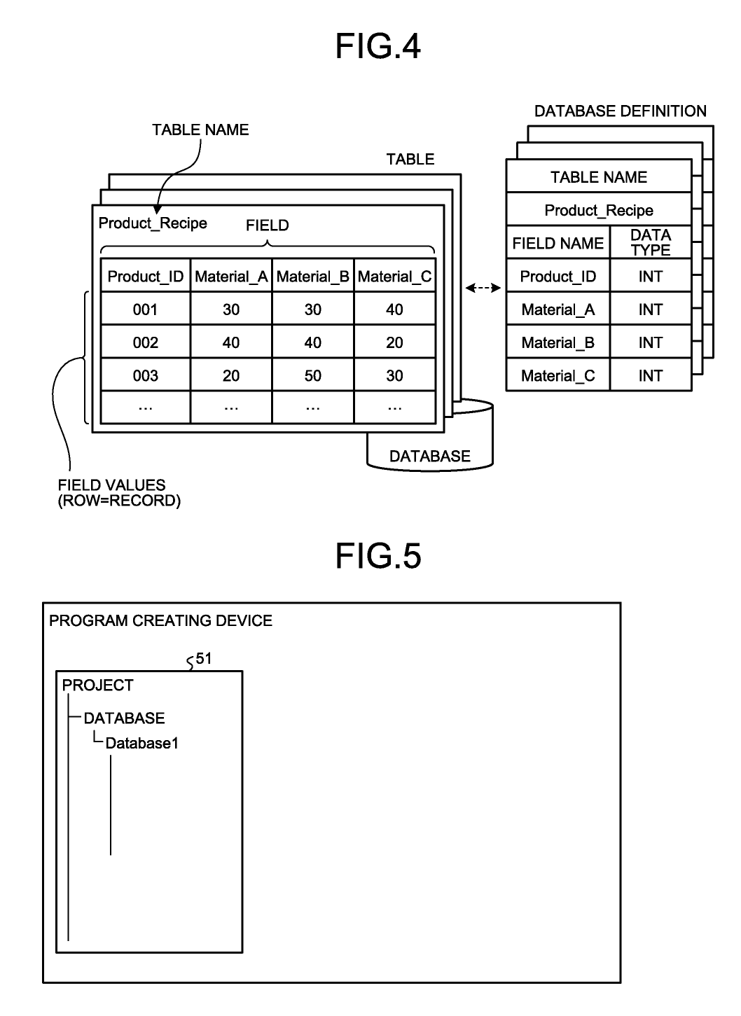

Here, the definition information of a table will be described with reference to FIG. 4. FIG. 4 is a diagram for explaining definition information of a table acquired by the program creating device 1 according to the first embodiment.

As illustrated in FIG. 4, a table included in a database has a plurality of regions defined by records and fields, and data are stored in each of the regions. Names are given to the tables and to the fields. In the example illustrated in FIG. 4, a table named “Product_Recipe” is included in the tables constituting the database. This table includes fields named “Product_ID,” “Material_A,” “Material_B,” and “Material_C”. The definition information of this table is constituted, by “TABLE NAME” representing the name of the table, “FIELD NAME” representing the name of each field, and “DATA TYPE” representing the type of data stored in each field, as illustrated on the right side in FIG. 4. Note that a set of definition information pieces of the tables constituting the database will be referred to as database definition information herein. The database definition information is information representing the configuration of the database.

Turning back to description with FIG. 3, in step S11, the definition information acquiring unit 11 acquires the names of the tables constituting the database 23, that is table names, the names of the fields included in the tables, that is the field names, and the types of data stored in the fields, that is the data types, as definition information of the tables.

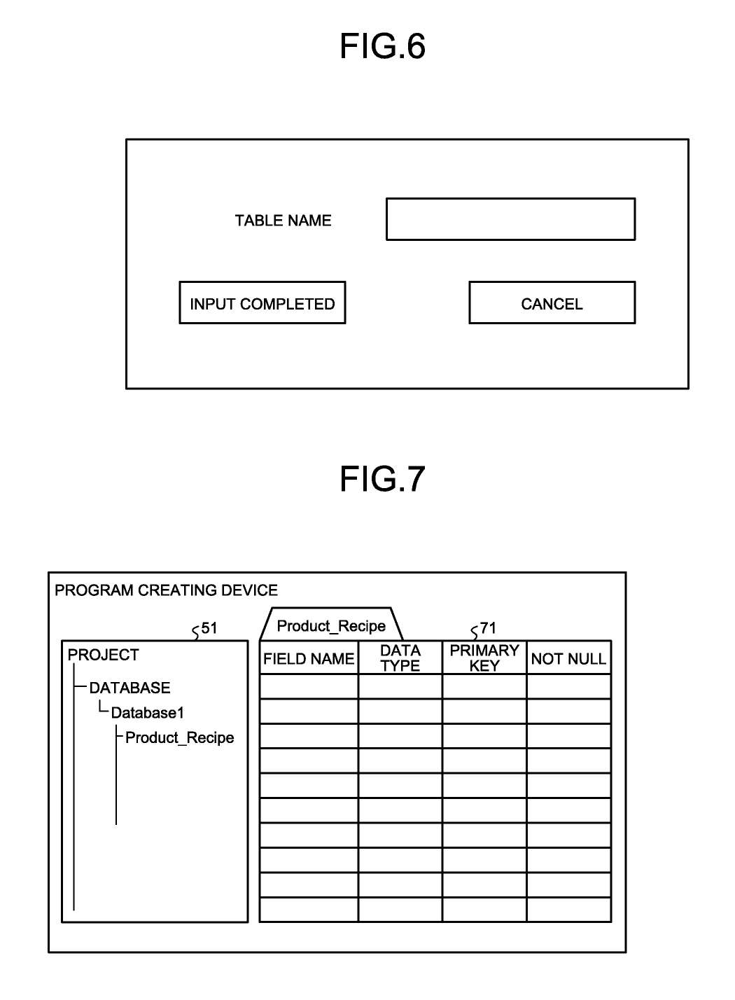

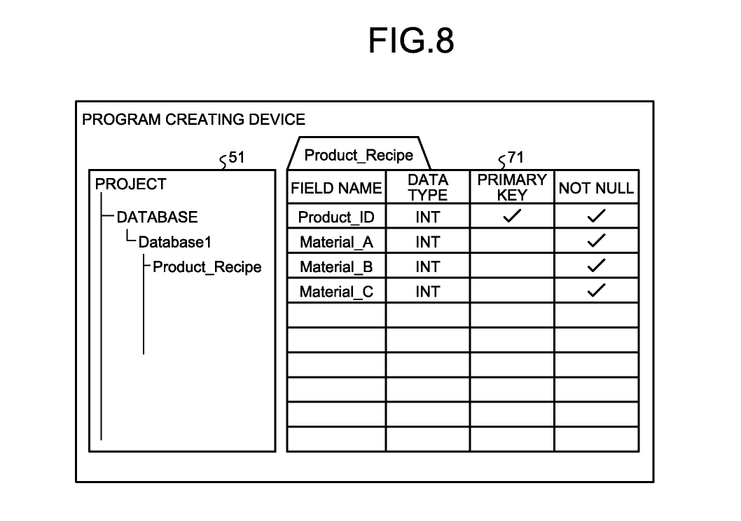

FIGS. 5 to 8 are diagrams for explaining operation of the program creating device 1 according to the first embodiment acquiring the definition information of a table from the user. FIG. 5 is a diagram illustrating an example of a window displaying a configuration of a project displayed by the program creating device 1 according to the first embodiment. FIG. 6 is a diagram illustrating an example of a screen displayed by the program creating device 1 according to the first embodiment after starting operation of acquiring definition information of a table from the user. FIG. 7 is a diagram illustrating an example of a screen of the program creating device 1 according to the first embodiment for receiving input of definition information of a table. FIG. 8 is a diagram illustrating an example of a screen displayed by the program creating device 1 according to the first embodiment after the device 1 receives input of the definition information of the table. Upon detecting that operation for starting input of the definition information of a table to be included in the database 23, the program creating device 1 displays the screen illustrated in FIG. 5 on the display device 101 illustrated in FIG. 2.

Upon detecting that the user has performed the operation mentioned below in a state in which a window 51 displaying the screen illustrated in FIG. 5, that is, the configuration of a project is displayed, the program creating device 1 determines that operation of inputting the definition information of a table is started, and displays the screens illustrated in FIG. 6. Note that the user performs operation by using an input device such as a mouse and a keyboard, that is, the input device 102 illustrated in FIG. 2. When the program creating device 1 has detected that “Databese1” below “DATABASE” illustrated in FIG. 5 is selected by the user and further that operation to instruct to newly input the definition information of a table is performed, the program creating device 1 displays the screen illustrated in FIG. 6. An example of a method of operation by which the user selects “Databese1” corresponds to operation of clicking “Databese1” with the mouse, but the user may select “Databese1” by other methods. In addition, an example of operation by which the user instructs to newly input the definition information of a table corresponds to operation of clicking the right mouse button in a state in which “Databese1” is selected to display a selectable menu and selecting “input of definition information of table” from the displayed menu. The program creating device 1 may display the screen illustrated in FIG. 6 with being superimposed on the screen illustrated in FIG. 5. FIG. 6 illustrates an example of a screen display for inputting the name of the table having the newly inputted definition information.

When “TABLE NAME” is inputted and the “INPUT COMPLETED” button is further selected, that is, clicked in a state in which the screen illustrated in FIG. 6 is displayed, the program creating device 1 displays the screen illustrated in FIG. 7. Here, the description will be continued on the assumption that “Product_Recipe” is inputted as the table name. As illustrated in FIG. 7, the program creating device 1 additionally displays the inputted table name “Product_Recipe” below “Databese1” in the window 51. The program creating device 1 also displays a window 71 for inputting configuration information of the table. The configuration information to be inputted by the user in the state in which the screen illustrated in FIG. 7 is displayed includes “FIELD NAME,” “DATA TYPE,” “PRIMARY KEY,” and “NOT NULL”. “FIELD NAME” and “DATA TYPE” are as described, with reference to FIG. 4. “PRIMARY KEY”represents a field in which data to be used for association with another table is stored. In other words, a table to be newly created is associated with another table with use of the data stored in the field set in “PRIMARY KEY”. “NOT NULL” represents a field, in which a null state, that is, a state in which no data is stored is not permitted. Thus, data always need to be stored in a field set with “DOT NULL”.

Upon detecting that operation of inputting the configuration information, that is, operation of inputting “FIELD NAME” and “DATA TYPE” and operation of setting “PRIMARY KEY” and “NOT NULL” have been performed in a state in which the screen illustrated in FIG. 7 is displayed, the program creating device 1 updates the screen display, that is, the display in the window 71 in accordance with the detected input operation. “DATA TYPE” may be inputted by selecting one from predefined types by pull down. FIG. 8 illustrates an example of screen display after the program creating device 1 has detected operation of inputting the configuration, information and performed update.

Upon detecting that an operation of terminating input of the configuration information, such as an operation of pressing such a button as “TABLE DEFINITION COMPLETED,” which is not illustrated, has been performed in a state in which the screen illustrated in FIG. 8 is displayed, the program creating device 1 terminates acquisition of the definition information of the table named “Product_Recipe”.

The program creating device 1 repeats the operation described with reference to FIGS. 5 to 8 to acquire the definition information of each of the tables constituting the database 23 in the PLC 2. Specifically, the user repeats operation similar to the above-described operation of inputting the definition information of the table named “Product_Recipe,” to input the definition information of the tables constituting the database 23 in the PLC 2 into the program creating device 1.

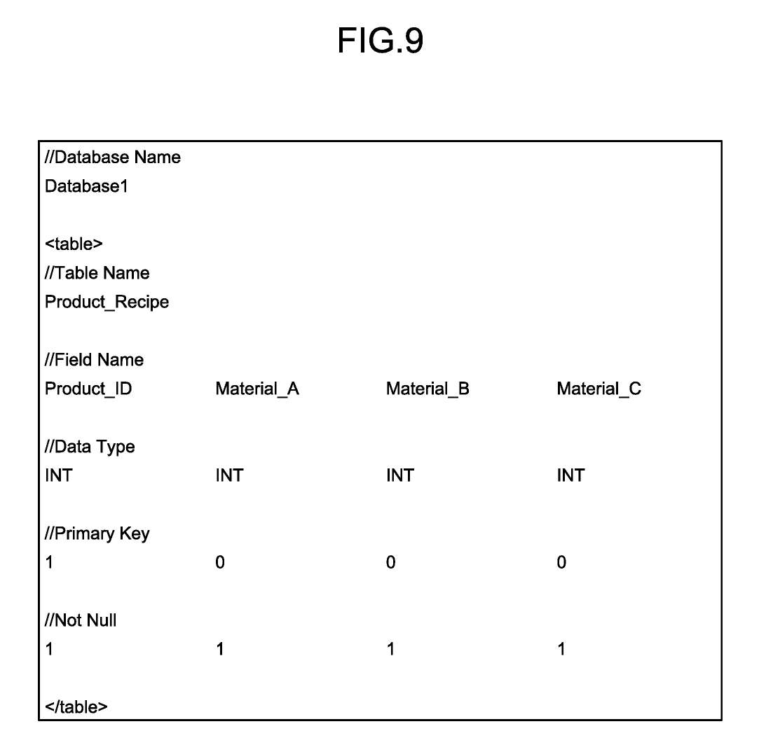

Upon receiving an operation of terminating input of the definition information of the tables constituting “Database1” and instructing to generate a DB definition file, such as an operation of pressing such a button as “GENERATE DATABASE DEFINITION FILE”, which is not illustrated, for example, the program creating device 1 generates a definition file of the database 23, that is, the DB definition file (step S12). In step S12, the DB definition file generating unit 12 of the program creating device 1 generates the DB definition file of the database 23 on the basis of the definition information of the tables inputted in step S11. As described above, the DB definition file is obtained by making the definition information of the respective tables constituting the database 23 perpetuated in a form of a file. Herein, the DB definition file is a set of files obtained by individually perpertuating the definition information of each of the tables included in the database definition. FIG. 9 is a diagram illustrating an example of a file included in the DB definition file generated by the program creating device 1 according to the first embodiment, that is, a file obtained by perpetuating the definition information of one table. As illustrated in FIG. 9, the file obtained by perpetuating the definition information of a table includes “Database Name,” “Table Name,” “Field Name,” “Data Type,” “Primary Key,” and “Not Null”. The example illustrated in FIG. 5 is an example where the definition information of the table with the table name “Product_Recipe” is perpetuated in the form of a text file. Note that the format of a file is not limited to the text format. In addition, the file illustrated in FIG. 9 indicates that data stored, in the “Product_ID” field is set as a primary key, and that “Product_ID,” “Material_A,” “Material_B” and “Material_C” are set to “Not_Null”. The DB definition file generating unit 12 stores the generated DB definition file in the DB definition file storing unit 14.

Subsequently to the process of step S12, the program creating device 1 generates program components for operating the database 23 (step S13). In step S13, the program component generating unit 13 of the program creating device 1 generates program components on the basis of the definition information of a table acquired by the definition information acquiring unit 11 in step S11. As described above, the program components generated by the program component generating unit 13 are labels and FBs. The label generated by the program component generating unit 13 is variable definition for storing data of each table of the database 23. The FBs generated by the program component generating unit 13 are function definition for adding a record to each table of the database 23, function definition for updating a record of each table, function definition for deleting a record from each table, and function definition for searching each table for a record. In a case where the definition information acquiring unit 11 has acquired two or more sets of definition information of the table in step S11, the program component generating unit 13 generates program components on the basis of each set of definition information. Operation of the program component generating unit 13 to generate program components will be described later. The program component generating unit 13 stores the generated, program component in the program component storing unit 15.

Note that the program creating device 1 may execute steps S12 and S13 in reverse order or in parallel.

Subsequently to the process of step S13, the program creating device 1 transmits the DB definition file to the PLC 2 (step S14). Specifically, the program creating device 1 transmits the DB definition file stored in the DB definition file storing unit 14 to the PLC 2. Upon receiving the DB definition file, the PLC 2 stores the DB definition file in the DE definition file storing unit 22. In addition, in the PLC 2, the database generating unit 21 generates the database 23 by using the DB definition file held by the BE definition file storing unit 22. Specifically, the database generating unit 21 generates the database 23 on the basis of information such as the database name, the table names, the field names in each table, and the data type of data to be stored in each field, which are included in the DB definition file.

Subsequently, the program creating device 1 creates a program for the PLC 2 by using the program components (step S15). This step S15 may alternatively be performed before step S14 or in parallel with step S14. The operation of creating a program for the PLC 2 is started upon receiving an operation of instructing to start the creation from the user. In step S15, the program creating unit 16 receives an operation from the user, and creates a program according to the content of the received operation. Since the technique of creating a program using program components is a conventional technique, explanation thereof is emitted herein. The operation of creating a program includes operations from compiling the program to creating a program file in an executable form. The program file created by the program creating unit 16 is stored in the program file storing unit 17. Note that the method for creating a program by using the program components for operating the database 23 will be described later.

After completing creation of the program, the program creating device 1 transmits the program, that is, the program file held by the program file storing unit 17 to the PLC 2 (step S16). Upon receiving the program file, the PLC 2 stores the program file in the program file storing unit 25. The program file stored in the program file storing unit 25 is read by the program executing unit 24 when the PLC 2 starts operating. Specifically, when the PLC 2 starts operating, the program executing unit 24 reads and executes the program file from the program file storing unit 25.

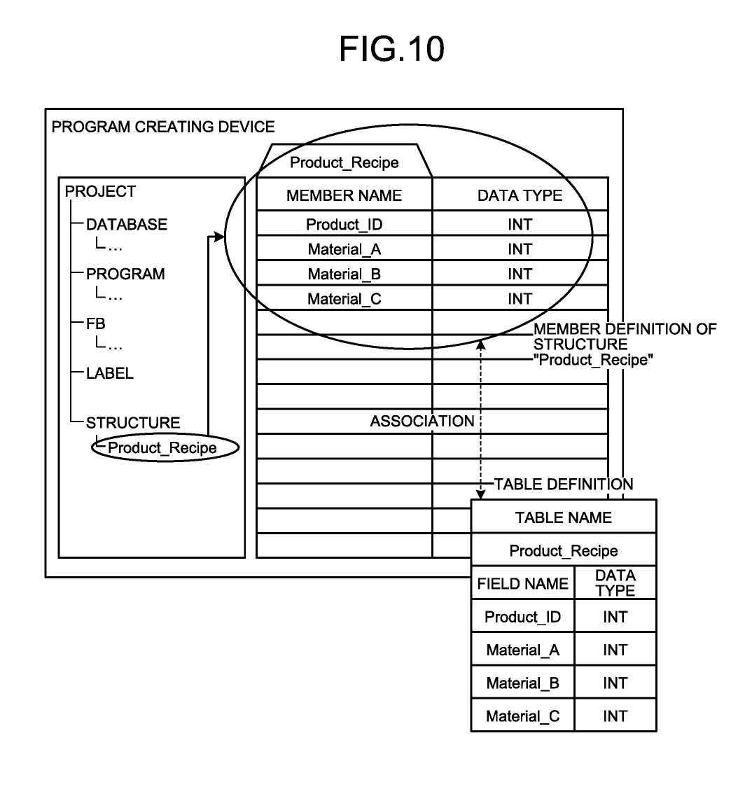

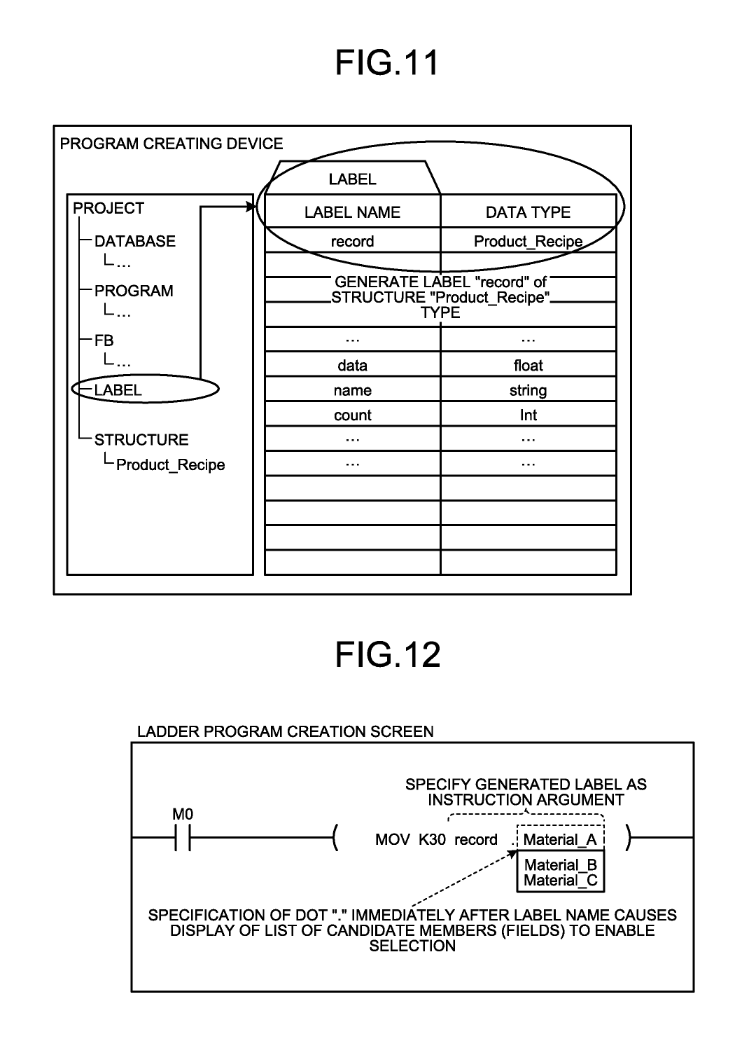

Next, procedures for the program component generating unit 13 to generate a label in step S13 described above will be explained with reference to FIGS. 10 and 11. FIGS. 10 and 11 are diagrams for explaining operation of the program component generating unit 13 of the program creating device 1 according to the first embodiment generating labels. FIG. 10 illustrates a stage in the process of the operation of the program component generating unit 13 generating a label, and FIG. 11 illustrates a state after generation of a label by the program component generating unit 13 is completed.

For generating labels, the program component generating unit 13 first generates a structure on the basis of each set of the definition information of the tables constituting the database definition information as illustrated in FIG. 10. In other words, the program component generating unit 13 generates definition information of the structure corresponding to the configuration of the table represented by the definition information (hereinafter referred to as structure definition information). Specifically, the program component generating unit 13 generates structure definition information of a structure in which each field name of the table is set as a member name. The data type of each member of the structure is a data type of data to be stored in each field of the table. In a case where the database definition information includes the definition information for two or more tables, the program component generating unit 13 generates structure definition information associated with each of the tables on the basis of the definition information of each of the tables. When the structure definition information is generated, a structure named “Product_Recipe” is added as a “STRUCTURE” constituting the “PROJECT” as illustrated in FIG. 10 is added. Subsequently, the program component generating unit 13 generates a label on the basis of each set of the generated structure definition information. In a case where a plurality of sets of structure definition information is present, the program component generating unit 13 generates a label corresponding to each set of the structure definition information. In other words, the program component generating unit 13 generates a label associated with each of the tables constituting the database 23. Specifically, the program component generating unit 13 creates a label in which a type definition of the generated structure is a data type. As a result, as illustrated in FIG. 11, the created label is added to a list of available labels. FIG. 11 illustrates an example of a screen display in a case where the program component generating unit 13 has generated a label in a state in which “data,” “name,” “count,” and so on are present as existing labels, and the generated, label has been added as a label, named “record”. As illustrated in FIG. 11, the generated label “record” is added to the label list. As a result, the label “record” can be used as a variable for storing data in the record of the corresponding table. Although detailed description will not be provided, the program component generating unit 13 generates a label “results” having the same configuration as the label “record”, in a similar manner. The label “results” is used for searching for a record registered in the database. An example of a method of using the label “results” will be described later.

A method of using a label generated by the program component generating unit 13 in creating a program will be described. FIG. 12 is a diagram illustrating an example of the method for using a label generated by the program creating device 1 according to the first embodiment. As illustrated in FIG. 12, for creating a program using a label, the user inputs, that is, writes a label name, and further writes a dot “.” immediately after the label name. Accordingly, a list of candidate members, that is, a list of fields is displayed. The user selects a member associated with a field in which data is stored from among the displayed members. Note that an “MOV” instruction is an instruction for assigning a value specified as a first argument to a second argument. Thus, “MOV K30 record Material_A” illustrated in FIG. 12 means that 30 in decimal notation, represented by “K30”, is assigned, to a member “Material_A” of a label “record”. In the case of “MOV K30 record. Material_B,” 30 in decimal notation is to be assigned to a member “Material_B” of the label “record”.

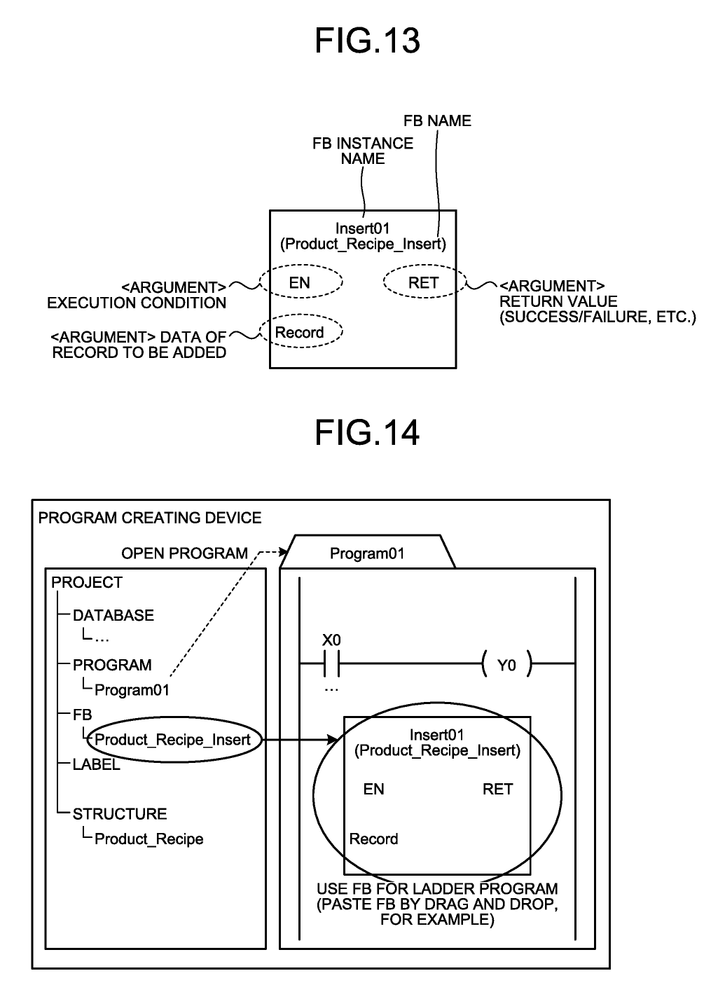

Next, operation of the program component generating unit 13 to generate an FB will be described. FIG. 13 is a diagram illustrating a record addition FB to be used in an operation of adding a record into a database, the FB being one of FBs generated by the program component generating unit 13. The program component generating unit 13 determines the name of the FB on the basis of the definition information of the table, and determines arguments to generate the FB. An FB has a fixed instance name, and the instance name of the record addition FB is set as “Insert01” in the example of FIG. 13. In addition the name of an FB is determined by adding a character string indicating a process for the FB to the name of the table. In the example illustrated in FIG. 13, “_Insert” is used as the character string indicating addition of a record. The record addition FB has a configuration arguments of which include an execution condition, data to be stored in the field of the record to be added, and a return value, and in which data of the record to be added is specified by a label whose label name is “record”. EN represents the execution condition, Record represents the data of the record to be added, and RET represents the return value.

While the operation of the program component generating unit 13 generating a record addition FB has been described, a similar manner resides in an operation of generating a record deletion FB to be used for operation of deleting a record from a database, an operation of generating a record update FB to be used for operation of updating a record in a database, and an operation of generating a record search FB to be used for operation of searching for a desired record in a database.

For generating a record deletion FB, the program component generating unit 13 determines the name of the record deletion FB on the basis of the definition information of the table, and determines arguments. The name is constituted by the name of the table plus “_Delete”. The arguments are an execution condition, a return value, and a search key for a record to be deleted. Similarly to the record addition FB, the instance name is fixed, which is “Deleted01” in this example. For generating a record update FB, the program component generating unit 13 determines the name of the record update FB on the basis of the definition information of the table, and determines arguments. The name is constituted by the name of the table plus “_Update”. The arguments are an execution condition, a return value, a search key for a record to be updated, and data to be stored in each field of the record to be updated. Similarly to the record addition FB and so on, the instance name is fixed, which is “Update01” in this example. For generating a record search FB, the program component generating unit 13 determines the name of the record search FB on the basis of the definition information of the table, and determines arguments. The name is constituted by the name of the table plus “_Select”. The arguments are an execution condition, a return value, a search key for a record, and a search result. Similarly to the record addition FB and so on, the instance name is fixed, which is “Select01” in this example.

Next, a method of creating a ladder program by using an FB generated by the program component generating unit 13 will be described. FIG. 14 is a diagram illustrating an example of a screen displayed by the program creating device 1 according to the first embodiment. FIG. 14 illustrates an example of a screen displaying a window for displaying a project on the left, and displaying a window for creating a ladder program on the right. The user selects, for example, an FB to be used from among the FBs displayed in the left window, and inserts the selected FB into the ladder program displayed in the right window by drag and drop. FIG. 14 illustrates an example of a case where the above-mentioned record addition FB is pasted.

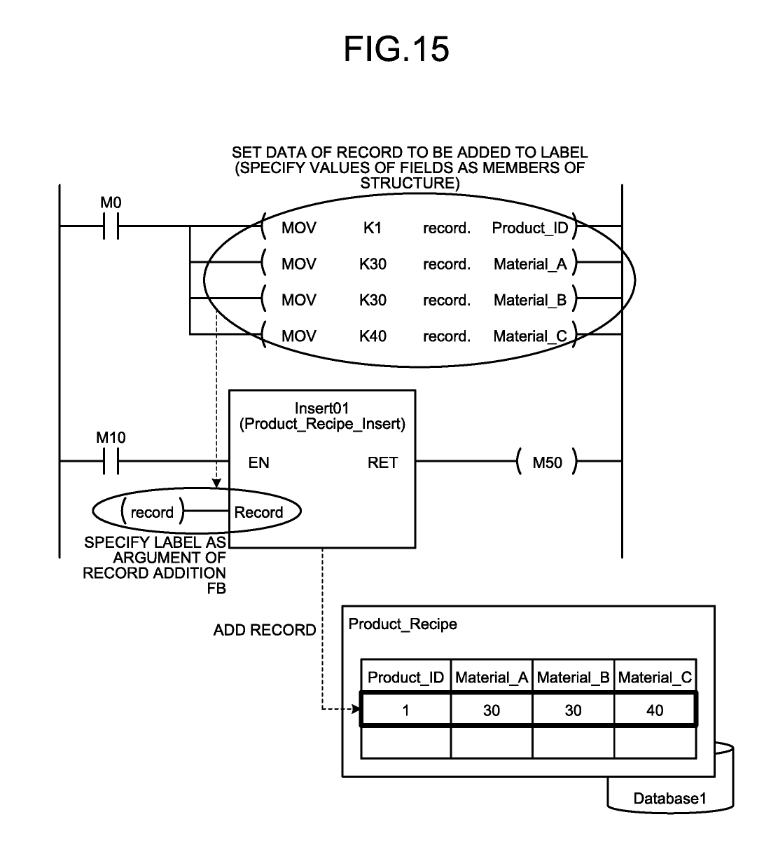

In the case where the record addition FB has been pasted in the window for creating a ladder program, the user subsequently creates record data to be added and creates additional processes of the created record data as illustrated in FIG. 15. The record data is created by assigning data of each field of the record to be added to each member of the label “record” having the structure type. In addition, the created record data is passed to the argument of the record addition FB. In the example illustrated in FIG. 15, “MOV K1 record. Product_ID,” “MOV K30 record. Material_A,” “MOV K30 record. Material_B,” and “MOV K40 record. Material_C” correspond to processes of creating record data by assigning data to the members of “record”.

Operation of the ladder program illustrated in FIG. 15 is as follows.

(1) When M10 (a bit device) is switched ON,

(2) the FB instance “Insert01” adds “record” specified as an argument to the database, and

(3) a return value (1: success or 0: failure) is stored in M50 (a bit device).

When the ladder program illustrated in FIG. 15 is gotten running, a record, with Product_ID being “1,” Material_A and Material_B being “30,” and Material_C being “40” is added to the table named Product_Recipe in Database1 as illustrated in the lower right part of FIG. 15.

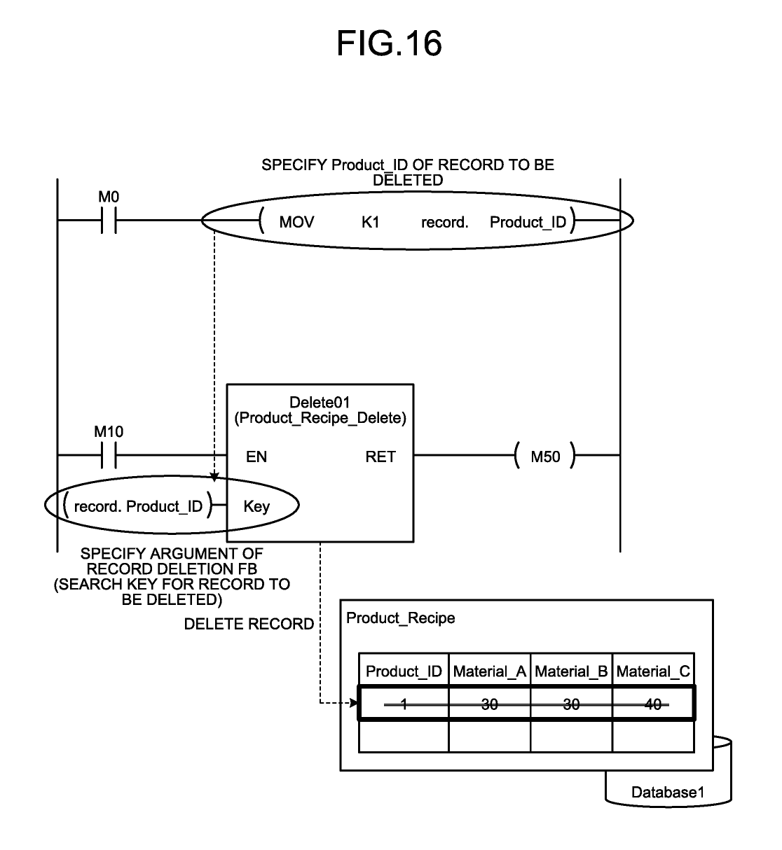

FIG. 16 is a diagram illustrating an example of a ladder program using a record deletion FB. For creating a program using a record deletion FB, the user inserts the record deletion FB into a ladder program, and then specifies a record to be deleted by using “Product_ID”. The content of the ladder program illustrated in FIG. 16 includes executing “MOV K1 record. Product_ID” before executing the FB of Delete01 that is the record deletion FB. In addition, the content includes giving “record. Product_ID” as a search key for a record to be deleted to the FB of Deleted01. When the ladder program illustrated in FIG. 16 is executed, a record with Product_ID being “1” is deleted from the table named Product_Recipe.

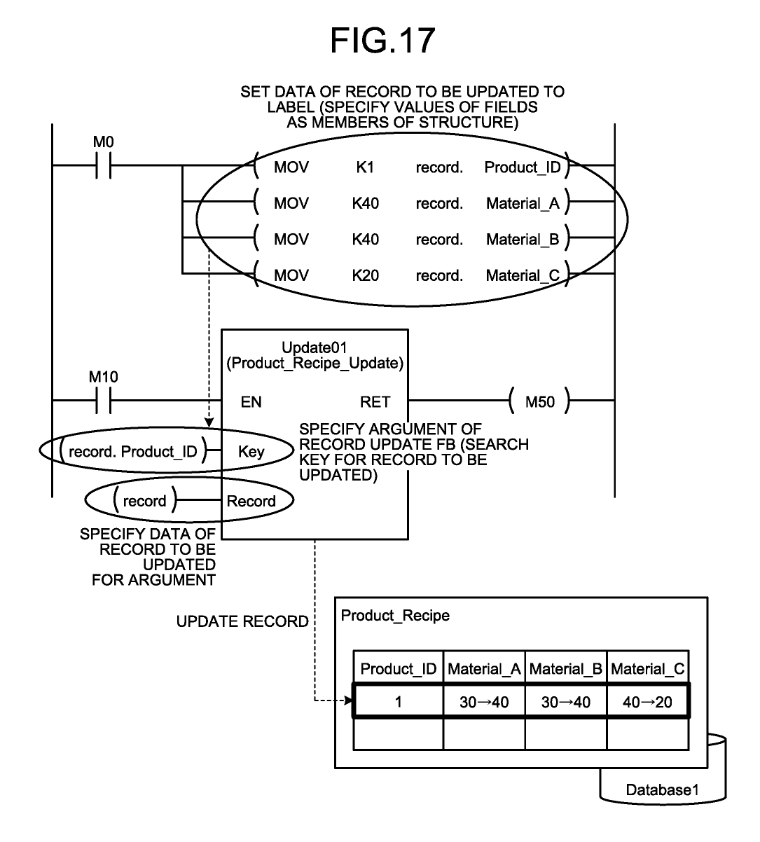

FIG. 17 is a diagram illustrating an example of a ladder program using a record update FB. For creating a program using a record update FB, the user inserts the record update FB into a ladder program, then specifies a record to be updated by using “Product_ID,” and updates data in each field by using “record”. The content of the ladder program illustrated in FIG. 17 includes executing “MOV K1 record. Product_ID,” “MOV K40 record. Material_A,” “MOV K40 record. Material_B,” and “MOV K20 record. Material_C” before executing the FB of Update01 that is the record update FB. In addition, the content includes giving “record. Product_ID” as a search, key for a record to be updated, and giving “record” as data to be stored in each field of the record to the FB of Update01. When the ladder program illustrated in FIG. 17 is executed, a record with Product_ID being “1” in the table named. Product Recipe is updated. Specifically, “Material_A” and “Material_B” are updated, with 40, and “Material_C” is updated with 20.

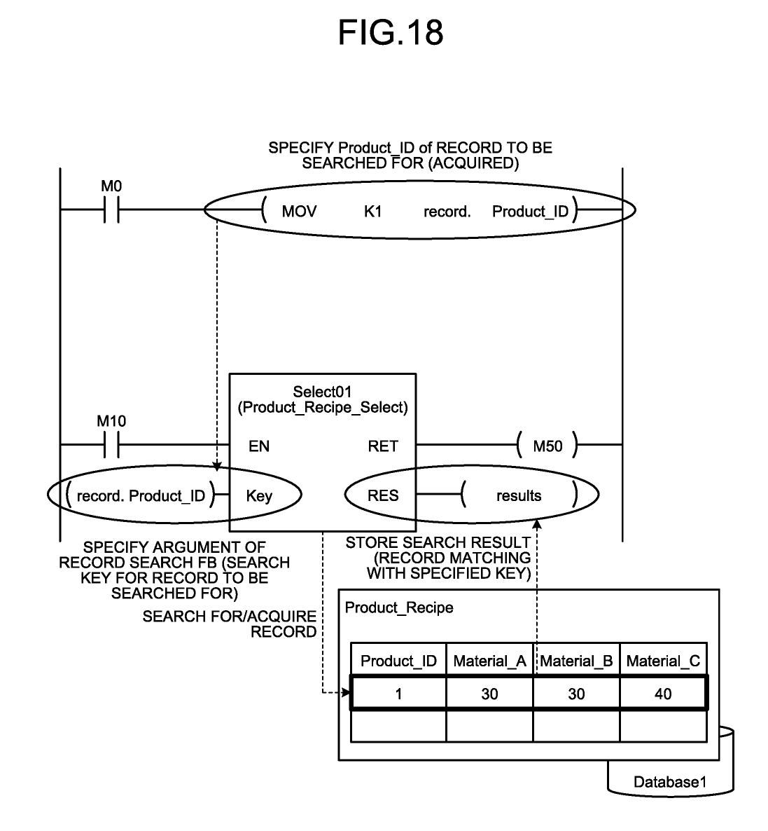

FIG. 18 is a diagram illustrating an example of a ladder program using a record search FB. For creating a program using a record search FB, the user inserts the record search FB into a ladder program, and then specifies a record to be searched for by using “Product_ID”. The content of the ladder program illustrated in FIG. 18 includes executing “MOV K1 record. Product ID” before executing the FB of Select01 that is the record search FB. In addition, the content includes giving “record. Product_ID” as a search key for the record to the FB of Select01. When, the ladder program illustrated in FIG. 18 is executed, a record with Product_ID being “1” in the table named Product_Recipe is searched for. If the relevant record, that is, the record with Product_ID being “1” is present as a result of the search, the FB of Select01 stores the data of the record in the label “results” specified as an output argument “RES”. Note that the label “results” in which the search result is stored is a variable of “Product_recipe” type, similarly to the label “record”. In a case where the number of search results is more than one, the “results” is an array (structure array). The label “results” is generated at the same time as the program component generating unit 13 generates the label “record”. In the example illustrated in FIG. 18, the data stored in each field of the record with Product_ID being “1” is stored in each member of “results”.

Next, a program file obtained by compiling a program by the program creating unit 16 will be described.

In a program file, a program is expressed as instruction strings for the PLC. The various FBs for database operation generated by the program component generating unit 13 are also each converted or compiled into an FB call instruction, and saved in a program file. An FB call instruction is not limited to use for an FB for database operation but is similarly used for a normal FB, and is used to execute a call of a subroutine specified for an argument. In addition, a value specified for an argument of an FB is specified as an argument to be passed to a subroutine. In a case where an FB for database operation is converted, however, subject database and table are specified in addition to the value specified for an argument of the FB. Unlike a normal FB, an application programming interface (API) included in the database management system (DBMS) of the PLC 2 is invoked as a subroutine.

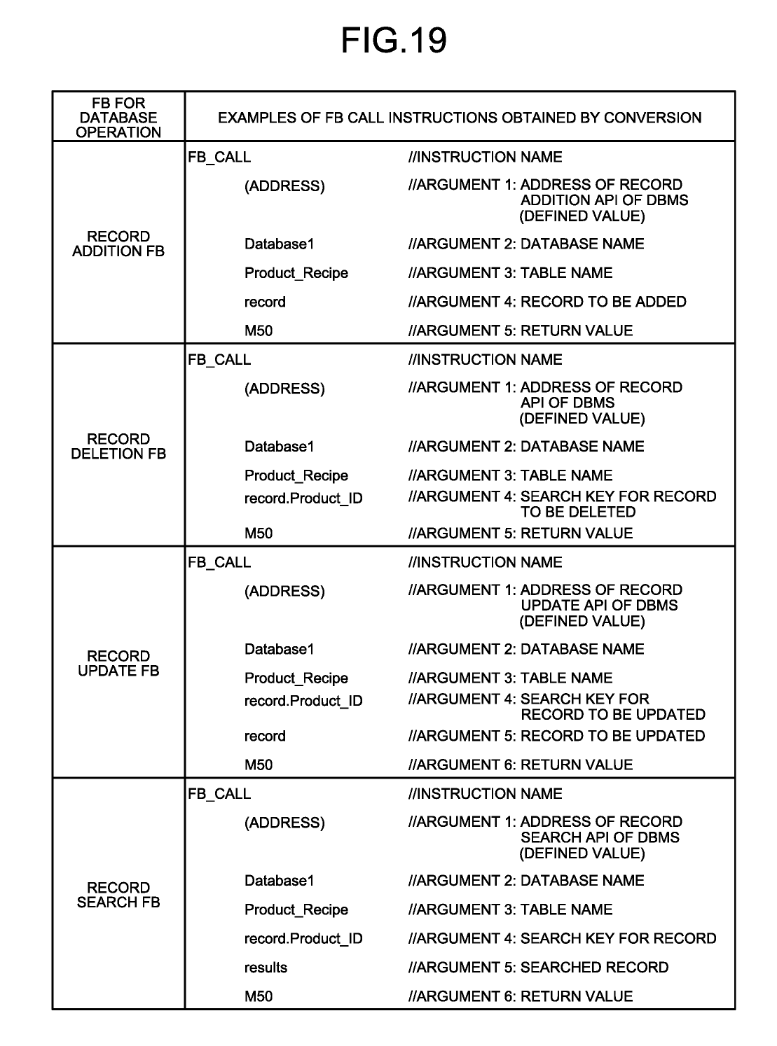

FIG. 19 is a diagram illustrating an example of an FB call-up instruction obtained by converting an FB for database operation by the program creating device 1 according to the first embodiment. Note that, when converting each FB for database operation, the program creating unit 16 checks whether or not a value specified for an argument of each FB is acceptable. In particular, it is checked whether or not an argument specifying a record for operating a table or an argument specifying a search key is specified by using a label associated with the table. In a case where an argument specifying a record for operating a table or an argument specifying a search key is not specified by using the associated label, the program creating unit 16 determines conversion error to occur.

Next, operation of the PLC 2 executing the program file generated by the program cremating unit 16 will be described.

The program file generated by the program creating unit 16 of the program creating device 1 is transmitted to the PLC 2 via the communication unit 18 and stored in the program file storing unit 25. In the PLC 2, the program executing unit 24 reads the program file from the program file storing unit 25, and sequentially interprets and executes instructions described in the program file. Note that, upon detecting an FB call instruction for an FB for database operation, the program executing unit 24 carries out a process of calling the API included in the DBMS that manages the database 23, and performs operation on the database 23. The API may be a function that can be directly called by firmware of the PLC 2 or an SQL statement. Note that the database 23 to be operated itself is generated, by the database generating unit 21 on the basis of the DB definition file generated by the DB definition file generating unit 12 of the programming device 1. When generating the database 23, the database generating unit 21 generates the database based on calling the API of the DBMS. When the PLC 2 is shifted to an execution state in a state in which both the database 23 and the program for operating the database 23 are stored in a built-in memory included in the PLC 2, that is, the memory 4 illustrated in FIG. 2, the PLC 2 executes a program for accessing the database 23.

As described above, the program creating device 1 according to the present embodiment acquires the definition information of each of the tables constituting the database internally built in the PLC 2 from the user, and generates a DB definition file, and labels and FBs as program components for instruction of operation of the database on the basis of the acquired definition information. This enables elimination of complication in the work of creating a program for operating a database, and reduction in the amount of work required for creating a program. In the conventional art, a program for accessing a database needs to be created with an awareness of a memory map and database definition. For example, since data of a record to be added to a database has been stored in a device, the association between the data and an address has needed to be managed. In addition, it has been necessary to check with a database definition document or the like what fields a subject table includes in each case. In contrast, the program creating device 1 according to the present embodiment enables generation of labels having a structure type according to definition information of each of tables constituting a database, and allows the user to create a program for operation of the database by using the labels. The user therefore need not be aware of a memory map. In addition, it is possible to know what fields a database includes without referring to a database definition document or the like.

### Second Embodiment

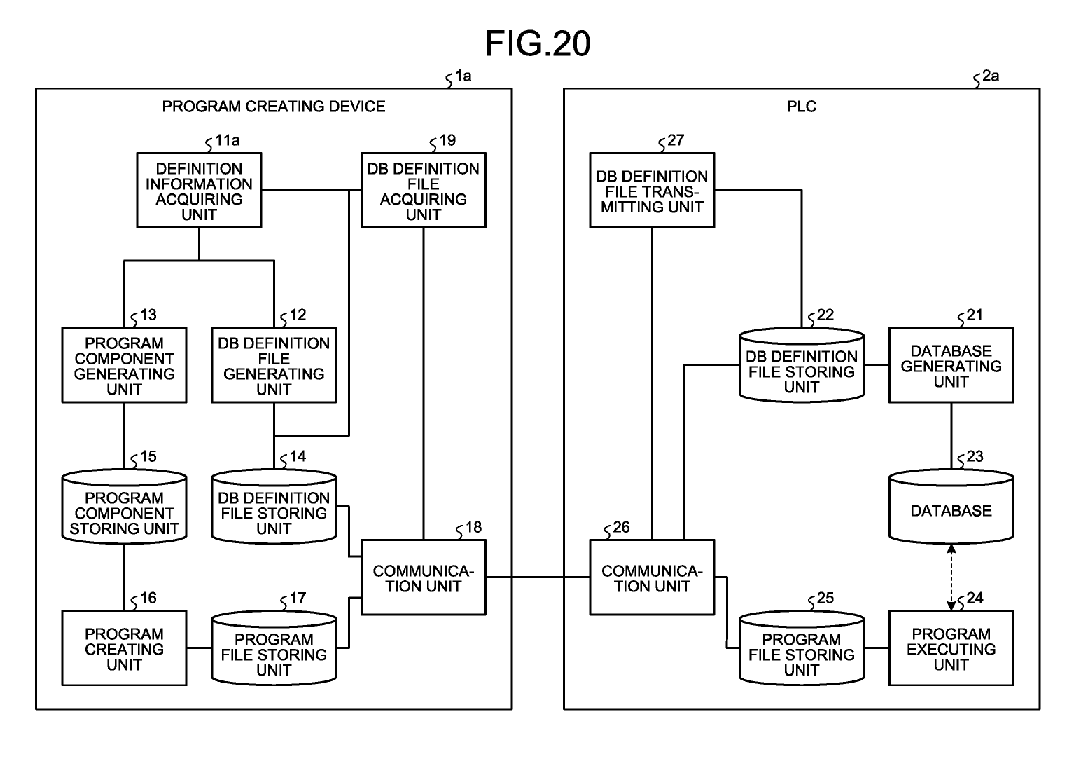

FIG. 20 is a diagram illustrating example configurations of a program creating device and a PLC that executes a program created by the program creating device according to a second embodiment of the present invention.

A program creating device 1a according to the second embodiment is obtained by using a definition information acquiring unit 11a instead of the definition information acquiring unit 11 of the program creating device 1 described in the first embodiment, and adding a DB definition file acquiring unit 19 thereto. Since components other than the definition information acquiring unit 11a and the DB definition file acquiring unit 19 of the program creating device 1a are the same as the components represented by the same reference numerals as in the program creating device 1, the description thereof will not be repeated. Similarly to the program creating device 1, the program creating device 1a can be implemented by the hardware 100 illustrated in FIG. 2.

The PLC 2a according to the second embodiment is obtained by adding a DB definition file transmitting unit 27 to the PLC 2 described in the first embodiment. Since components other than the DB definition file transmitting unit 27 of the PLC 2a are the same as the components represented by the same reference numerals as in the PLC 2, the description thereof will not be repeated.

As to operations of the program creating device 1a and the PLC 2a according to the present embodiment, description is given mainly for an operation of the definition information acquiring unit 11a and the DB definition file acquiring unit 19 of the program creating device 1a, and the DB definition file transmitting unit 27 of the PLC 2a.

Upon detecting that an operation of instructing to read the DB definition file from the PLC 2a has been performed by the user, the DB definition file acquiring unit 19 requests the DB definition file transmitting unit 27 of the PLC 2a to transmit the DB definition file.

Upon receiving the request for transmitting the DB definition file from the DB definition file acquiring unit 19 of the program creating device 1a, the DB definition file transmitting unit 27 of the PDC 2a reads the DB definition file, if the DB definition file storing unit 22 stores the DB definition file, and transmits the DB definition file to the DB definition file acquiring unit 19 of the program creating device 1a.

Upon receiving the DB definition file from the DB definition file transmitting unit 27 of the PDC 2a, the BE definition file acquiring unit 19 of the program creating device 1a outputs the received DB definition file to the definition information acquiring unit 11a and stores the received DB definition file in the DB definition file storing unit 14.

Upon receiving the DB definition file from the DB definition file acquiring unit 19, the definition information acquiring unit 11a analyzes the DB definition file, and extracts database definition information necessary for the program component generating unit 13 to generate program components to output the extracted database definition information to the program component generating unit 13. In other words, the definition information acquiring unit 11a acquires the database definition information of the database 23 built in the PLC 2a from the PLC 2a. Note that the definition information acquiring unit 11a also has the function of the definition information acquiring unit 11 described in the first embodiment, that is, the function of acquiring database definition information from the user.

Alternatively, upon receiving the request for transmitting the DB definition file, the DB definition file transmitting unit 27 of the PLC 2a may acquire database definition information from the database 23, generate a DB definition file using the acquired database definition information, and transmit the DB definition file to the DB definition file acquiring unit 19 of the program creating device 1a. In this case, the DB definition file transmitting unit 27 acquires the database definition information from the database 23 using the API of the DBMS.

As described above, the program, creating device 1a according to the present embodiment includes the DB definition file acquiring unit 19 configured to acquire the DB definition file of an existing database from the PLC 2a, and generates program components for an instruction of operation of the database on the basis of the DB definition file acquired by the DB definition file acquiring unit 19. The program creating device 1a according to the present embodiment enables an existing database resource to be diverted, and the number of processes in designing a program for operating the database to be reduced. For example, the program creating device 1a connects with the PLC 2a having a state in which generation of the database 23 has been completed based on a DB definition file different from the DB definition file generated by the program creating device 1a, and generates program components on the basis of the DB definition file acquired from the PLC 2a. As a result, the user of the program creating device 1a can modify a program of the PLC 2a by using the program components generated based on the existing DB definition file.

In the embodiments, the program component generating unit 13 generates, as program components, function definition for adding a record to each table of the database 23, function definition for updating a record of each table, function definition for deleting a record from each table, and function definition for searching each table for a record. However, the operation of the program component generating unit 13 is merely an example, and the program component generating unit 13 may generate function definitions representing other operations on the database 23 as program components. In addition, the program component generating unit 13 may have a configuration for generating at least one of the above-described function definitions.

The configurations presented in the embodiments above are examples of the present invention, and can be combined with other publicly known techniques or partly omitted and/or modified without departing from the scope of the present invention.

### REFERENCE SIGNS LIST

1, 1a program creating device; 2, 2a programmable logic controller; 11, 11a definition information acquiring unit; 12 DB definition file generating unit; 13 program component generating unit; 14 DB definition file storing unit; 15 program component storing unit; 16 program creating unit; 17, 23 program file storing unit; 18, 26 communication unit; 19 DB definition file acquiring unit; 21 database generating unit; 22 DB definition file storing unit; 23 database; 24 program executing unit; 27 DB definition file transmitting unit.

1. A program creating device comprising:
definition information acquiring circuitry to acquire database definition information that is information indicating a configuration of a database in a programmable logic controller; and
program component generating circuitry to generate a program component to be used for creating a program to be executed by the program logic controller, the program component being to be used when a user creates an instruction to operate the database, on the basis of the database definition information.

2. The program creating device according to claim 1, wherein the definition information acquiring circuitry acquires the database definition information from a user.

3. The program creating device according to claim 1, wherein the definition information acquiring circuitry acquires the database definition information from a programmable logic controller whose database has been built therein.

4. The program creating device according to claim 1 comprising:
a database definition file generating circuitry to generate a database definition file on the basis of the database definition information; and
a communication circuitry to transmit the database definition file to the programmable logic controller.

5. The program creating device according to claim 1, wherein the program component generating circuitry generates, as the program components, variable definitions for specifying a record and a field of a table constituting a database and function definitions for specifying operations to be performed on the record and the field specified by the variable definitions.

6. The program creating device according to claim 1, comprising a program creating circuitry to create the program using the program component.

7. The program creating device according to claim 1, wherein the database definition information represents a name of a table constituting the database, a name of each field included in the table, and a type of data stored in each field.

8. The program creating device according to claim 1, wherein the program component generating circuitry generates, as a program component or program components, at least one of a function definition for adding a record to a table constituting the database, a function definition for deleting a record from the table, a function definition for updating a record in the table, and a function definition for search for a record in the table.
